(19) United States
(12) Patent Application Publication
(10) Pub. No.: US 2023/0353678 A1
(43) Pub. Date: Nov. 2, 2023

(54) PROVIDING SPATIAL AUDIO IN VIRTUAL CONFERENCES

(71) Applicant: Zoom Video Communications, Inc., San Jose, CA (US)

(72) Inventors: Zhaofeng JIA, Saratoga, CA (US); Rui Li, Hangzhou (CN); Qiyong Liu, Singapore (SG); Mengfan Zhang, Mountain View, CA (US)

(73) Assignee: Zoom Video Communications, Inc., San Jose, CA (US)

(21) Appl. No.: 17/897,978

(22) Filed: Aug. 29, 2022

Related U.S. Application Data
(63) Continuation of application No. PCT/CN2022/090637, filed on Apr. 29, 2022.

(51) Int. Cl. H04M 3/56

(52) U.S. Cl. CPC H04M 3/568

(57) ABSTRACT

One example method for providing spatial audio in virtual conference includes receiving, at a client device from a conference provider, an audio stream associated with an audio source, the audio stream provided by a remote client device, the client device and the remote client device participating in a virtual conference hosted by the conference provider, the client device associated with a user; determining a location of the audio source in the virtual conference with respect to the user's head; generating a plurality of spatialized audio streams based on the locations of the audio source and the audio stream; and outputting the spatialized audio streams.

### CROSS-REFERENCE

This application is a continuation of PCT Application No. PCT/CN2022/090637, filed Apr. 29, 2022, titled “Providing Spatial Audio in Virtual Conferences,” the entirety of which is incorporated by reference herein.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-3 show examples systems for providing spatial audio in virtual conferences;

FIGS. 4-6 show example graphical user interfaces (“GUIs”) for providing spatial audio in virtual conferences;

FIG. 7 shows an example representation of a virtual conference room to provide spatial audio in virtual conferences;

FIG. 8 shows an example representation of a user's head and multiple audio sources within a virtual conference;

FIG. 9 shows an example client device for providing spatial audio in virtual conferences;

FIG. 10 shows an example method for providing spatial audio in virtual conferences; and

FIG. 11 shows an example computing device suitable for example systems and methods for providing spatial audio in virtual conferences.

### DETAILED DESCRIPTION

Examples are described herein in the context of providing spatial audio in virtual conferences. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

People participate in video conferences for a wide variety of reasons, such as to keep in touch with family, conduct business, or manage groups or organizations. Frequently, people attend video conferences using their own personal client device, such as a desktop or laptop computer, tablet, or smartphone. As a result, there is no sense of spatial separation for the participants in the video conference. To help alleviate the sense of being physically disconnected from the other participants, a video conference provider may enable participants to use a background image and to array video streams from the participants around the background image to give some sense of connectedness during the video conference. However, despite the visual appearance of being physically gathered together, audio from each participant still is provided as though each speaker is directly in front of the participant.

To provide a more immersive and realistic experience, a user's client device may determine locations of each participant within a virtual conference room based on their respective positions overlaid onto the background image. Thus, the client device may generate a virtual three-dimensional space and position each participant within the virtual space. A participant's client device may then determine the relative positioning of other participants with respect to the participant themselves. When another participant speaks during the conference, the client device may modify the received audio stream from that other participant based on the relative positioning of the other participant, such as by adjusting a sound balance between left and right speakers or by adjusting a magnitude of the audio based on the distance from the participant. Some example may apply other effects as well, depending on the nature of the virtual room. For example, audio from a more distant speaker may be modified to add apparent echoes from the “walls” of the virtual conference room, providing the illusion that the speaker's voice is travelling a greater distance through the virtual conference room before arriving at the participant's ears.

In addition, the client device may analyze video captured by the participant's camera to determine their head's pose relative to the room. After determine their head's pose, the client device may then apply a head-related transfer function (“HRTF”) to adjust audio provided to each of the participant's ears to provide the illusion of presence within the virtual setting. In a real conference, a person's head pose affects how audio sources sound at each ear, thus, by employing an HRTF and the determined head pose, the client device can further adjust the audio stream to generate audio streams with different characteristics based on head pose. By providing spatial audio based on participant placement within a virtual conference room, such as in the examples above, a virtual conference may feel much more immersive and real than a conventional virtual conference, where each participant appears to be at the same location when speaking.

This illustrative example is given to introduce the reader to the general subject matter discussed herein and the disclosure is not limited to this example. The following sections describe various additional non-limiting examples and examples of providing spatial audio in virtual conferences.

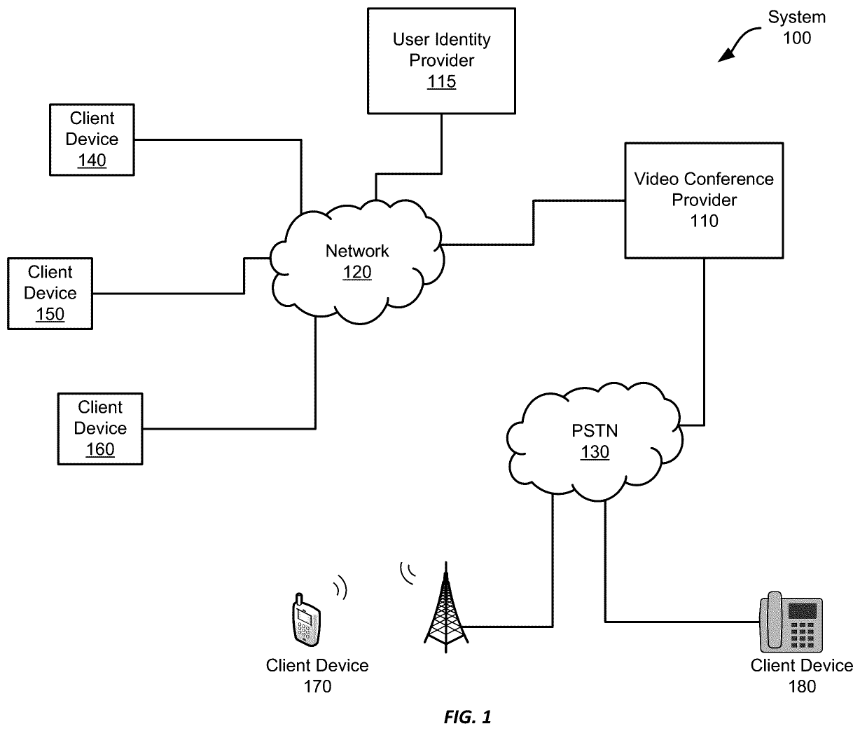

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the video conference provider 110. For example, the video conference provider 120 can be located within a private network to provide video conferencing services to devices within the private network, or it can be connected to a public network, e.g., the internet, so it may be accessed by anyone. Some examples may even provide a hybrid model in which a video conference provider 120 may supply components to enable a private organization to host private internal video conferences or to connect its system to the video conference provider 120 over a public network.

The system optionally also includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity.

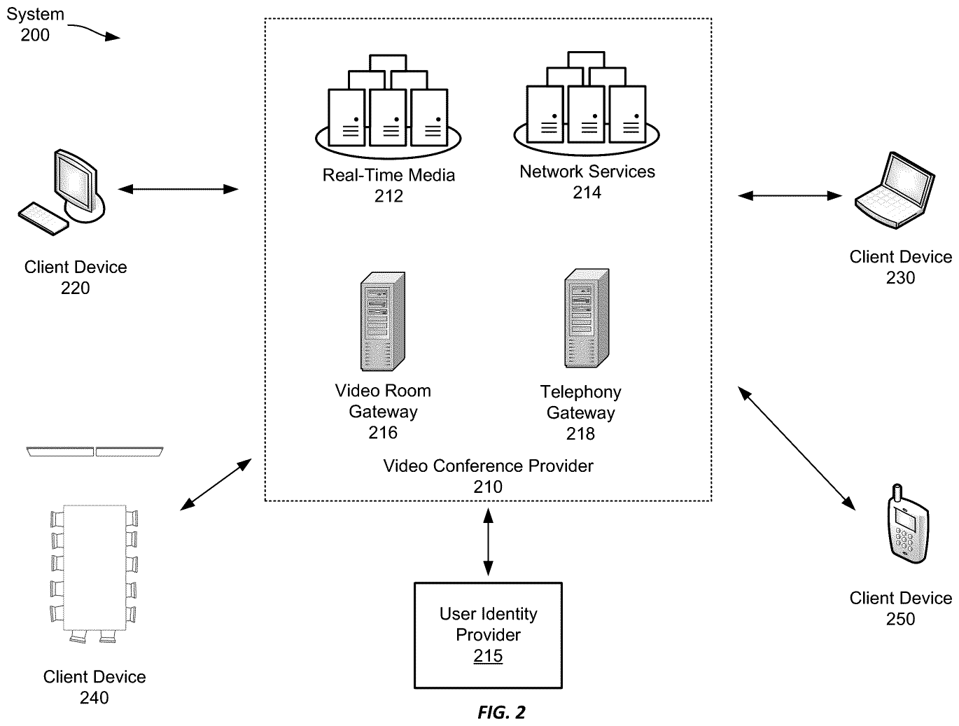

Video conference provider 110 allows clients to create videoconference meetings (or “meetings”) and invite others to participate in those meetings as well as perform other related functionality, such as recording the meetings, generating transcripts from meeting audio, manage user functionality in the meetings, enable text messaging during the meetings, create and manage breakout rooms from the main meeting, etc. FIG. 2, described below, provides a more detailed description of the architecture and functionality of the video conference provider 110.

Meetings in this example video conference provider 110 are provided in virtual “rooms” to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used. Further, in some examples, and as alluded to above, a meeting may also have “breakout” rooms. Such breakout rooms may also be rooms that are associated with a “main” videoconference room. Thus, participants in the main videoconference room may exit the room into a breakout room, e.g., to discuss a particular topic, before returning to the main room. The breakout rooms in this example are discrete meetings that are associated with the meeting in the main room. However, to join a breakout room, a participant must first enter the main room. A room may have any number of associated breakout rooms according to various examples.

To create a meeting with the video conference provider 110, a user may contact the video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the video conference provider 110 may prompt the user for certain information, such as a date, time, and duration for the meeting, a number of participants, a type of encryption to use, whether the meeting is confidential or open to the public, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating the that meeting has not yet started or the host may be required to specifically admit one or more of the users.

During the meeting, the participants may employ their client devices 140-180 to capture audio or video information and stream that information to the video conference provider 110. They also receive audio or video information from the video conference provider 210, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The video conference provider 110 may also invalidate the meeting information, such as the meeting identifier or password/passcode.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 110 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video conference provider 110.

When the user accesses the video conference provider 110 using a client device, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1.

In this example, the video conference provider 210 employs multiple different servers (or groups of servers) to provide different aspects of video conference functionality, thereby enabling the various client devices to create and participate in video conference meetings. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed streams to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference system 210. In some such examples, the real-time media servers 212 may decrypt incoming multimedia streams, multiplex the multimedia streams appropriately for the various clients, and encrypt the multiplexed streams for transmission.

In some examples, to provide multiplexed streams, the video conference provider 210 may receive multimedia streams from the various participants and publish those streams to the various participants to subscribe to and receive. Thus, the video conference provider 210 notifies a client device, e.g., client device 220, about various multimedia streams available from the other client devices 230-250, and the client device 220 can select which multimedia stream(s) to subscribe to and receive. In some examples, the video conference provider 210 may provide to each client device the available streams from the other client devices, but from the respective client device itself, though in other examples it may provide all available streams to all available client devices. Using such a multiplexing technique, the video conference provider 210 may enable multiple different streams of varying quality, thereby allowing client devices to change streams in real-time as needed, e.g., based on network bandwidth, latency, etc.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the client device 214 may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, creating sub-meetings or “break-out” rooms, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to create a break-out room for one or more meeting participants to join, such a command may also be handled by a network services server 214, which may create a new meeting record corresponding to the break-out room and then connect one or more meeting participants to the break-out room similarly to how it originally admitted the participants to the meeting itself.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider 210 when it is first installed and the video room gateway servers 216 may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

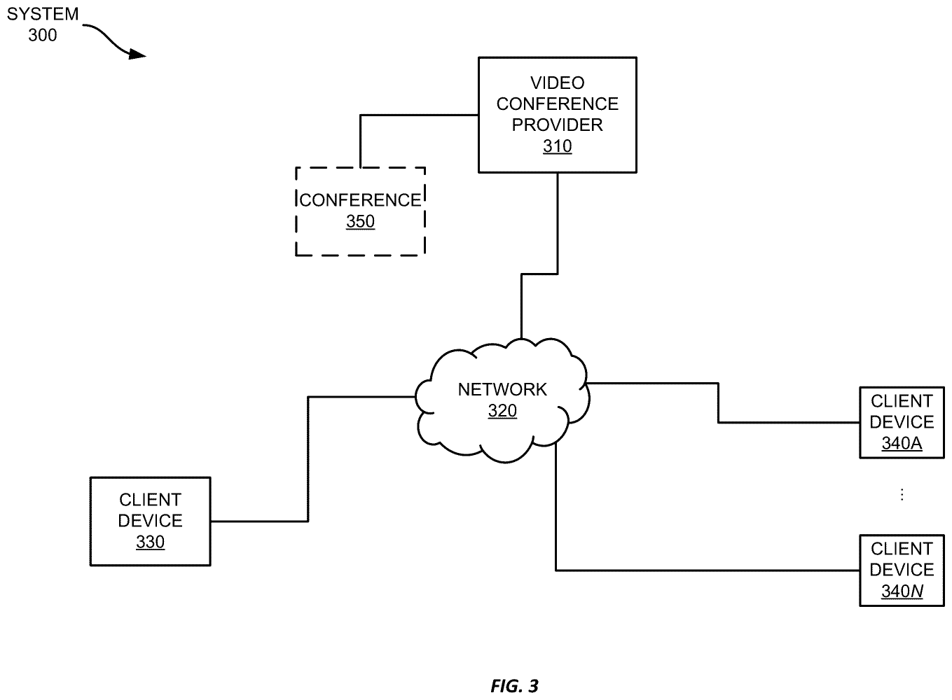

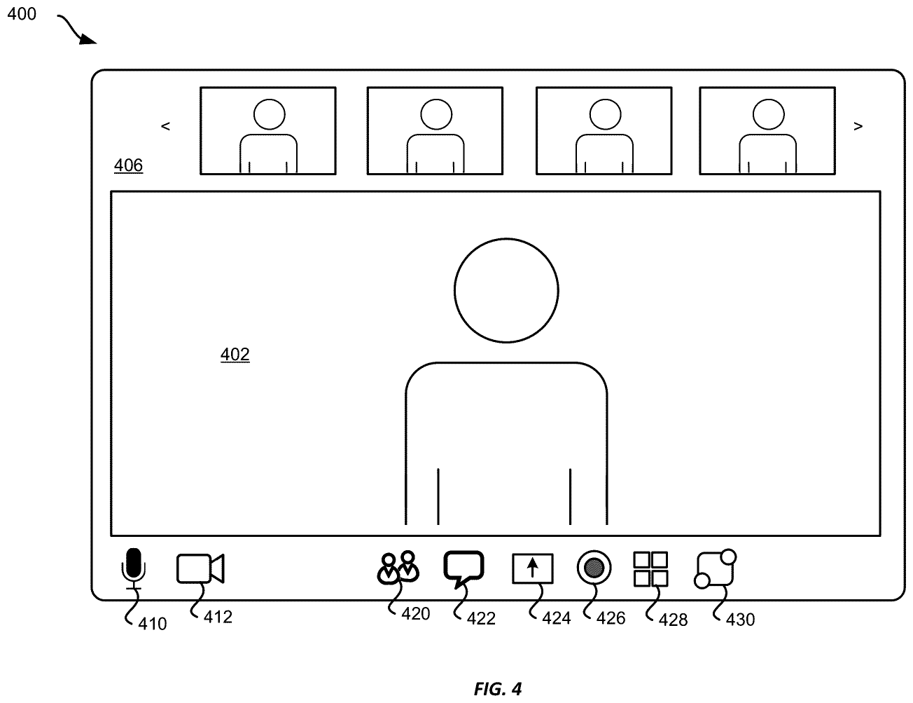

Referring now to FIG. 3, FIG. 3 shows an example system 300 for providing spatial audio in virtual conferences. In this example, a video conference provider 310 hosts a conference 350 for multiple participants, each employing a respective client device 330, 340a-n. In this example, the host of the conference 350 is connected to the conference 350 using client device 330, while the other client device 340a-n are used by other participants in the conference 350. To participate in a conference, each participant executes a conference client application (or “software client”) to connect to the video conference provider 310 and exchange audio and video streams. However, because the conference 350 occurs virtually and not in a physical conference room, the participants do not have any pre-established positional relationship with respect to each other. Thus, a speaking participant's audio as captured by a microphone is received and output by the other participants as though the other participants are located at the speaking participant's microphone. FIG. 4 illustrates the lack of positional relationship between the participants within the video conference.

FIG. 4 shows an example graphical user interface (“GUI”) for a software client in virtual conferences. A client device, e.g., client device 330 or client devices 340a-n, executes a software client, which in turn displays the GUI 400 on the client device's display. In this example, the GUI 400 includes a speaker view window 402 that presents the current speaker in the video conference. Above the speaker view window 402 are smaller participant windows 404, which allow the participant to view some of the other participants in the video conference, as well as controls (“<” and “>”) to let the host scroll to view other participants in the video conference.

Beneath the speaker view window 402 are a number of interactive elements 410-430 to allow the participant to interact with the video conference software. Controls 410-412 may allow the participant to toggle on or off audio or video streams captured by a microphone or camera connected to the client device. Control 420 allows the participant to view any other participants in the video conference with the participant, while control 422 allows the participant to send text messages to other participants, whether to specific participants or to the entire meeting. Control 424 allows the participant to share content from their client device. Control 426 allows the participant toggle recording of the meeting, and control 428 allows the user to select an option to join a breakout room. Control 430 allows a user to launch an app within the video conferencing software, such as to access content to share with other participants in the video conference.

During the normal course of a video conference, the user interacts with the software client and other participants via the GUI 400. However, because the software client positions the current speaking participant in the speaker window 402, everyone sounds and appears as though they are directly in front of the participant and with audio generally equally balanced between the user's left and right ears. This arrangement reinforces the fact that the conference is virtual and the participants are all remote from each other.

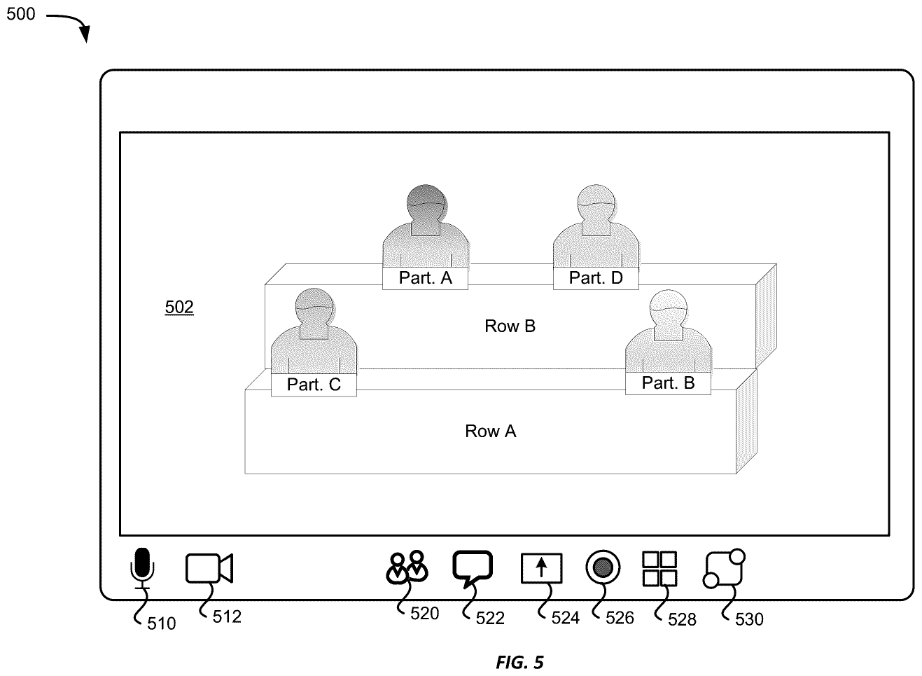

Referring now to FIG. 5, FIG. 5 illustrates a different GUI 500 provided by a software client that provides a more immersive view of the video conference. In this example GUI 500, the software client has applied a virtual background 502 in place of a speaker window 402. The virtual background 502 in this example provides virtual stadium seating having two rows for the participants in the conference. Each participant's video feed has been cropped to remove any background areas within the respective video feed, leaving only the respective participants head and torso within the video feed. Each video feed has been assigned to a specific location within a row in the virtual background 502. Thus, the participant is able to see the other participants within the conference positioned with respect to each other within a common location.

Such a virtual background 502 may be suitable for use by a teacher or professor to address their classroom, with the students arrayed among the rows. As will be discussed in more detail below, by providing spatial audio, audio feeds from different students will be modified to apparently originate from the respective student's locations within the virtual background 502. This may allow the teacher or professor to hear audio from each student from their apparent position within the classroom. For example, a student further from the teacher and to the teacher's left may be somewhat quieter or have more room-based reverberations or echoes. In addition, their audio streams may be output louder through a left speaker or headphone than a right speaker or headphone. Thus, as different students speak during the course of the class, the teacher or professor may be able to differentiate the students based on their apparent positions and to feel like they are actually standing at the head of the classroom.

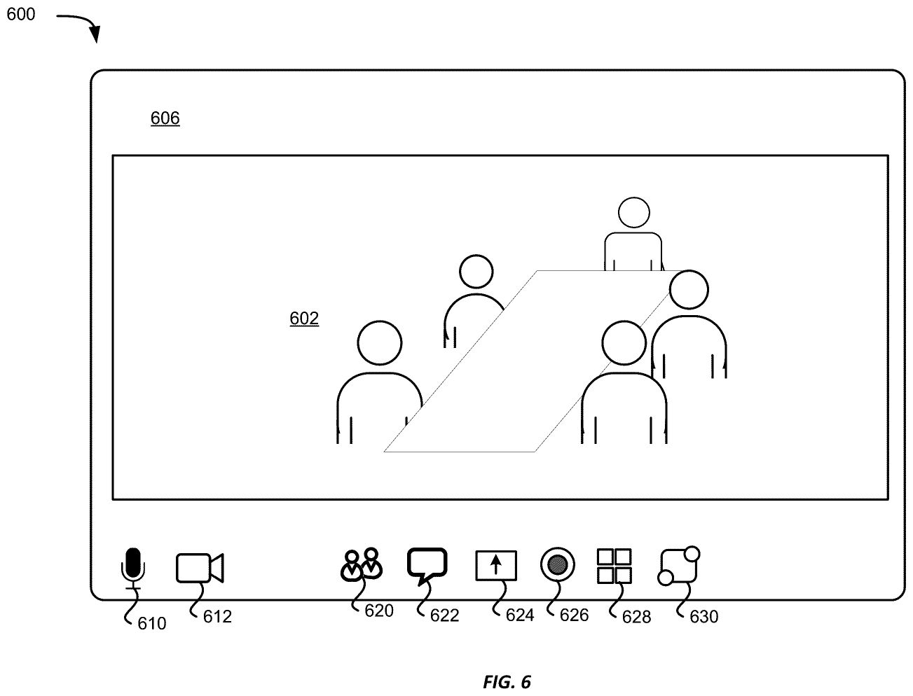

Referring now to FIG. 6, FIG. 6 shows another example GUI 600 for a software client for providing spatial audio in virtual conferences. As discussed above with respect to FIGS. 4 and 5, a client device, e.g., client device 330 or client devices 340a-n, executes a software client, which in turn displays the GUI 600 on the client device's display. Similar to the example shown in FIG. 5, the software client is using a virtual background 602; however in this example, the virtual background 602 represents a conference room with participants in the virtual conference appearing to be seated around the conference table. Such a virtual background 602 may be desirable for virtual business meetings and may allow the participants to feel more like they are physically present in a conference room than in a virtual conference.

As with the example shown in FIG. 5, each participant's video feed has been cropped to remove any background areas within the respective video feed, leaving only the respective participants head and torso within the video feed. Each video feed has been assigned to a specific location around the conference table in the virtual background 602. Thus, the participant is able to see the other participants within the conference positioned with respect to each other within a common location.

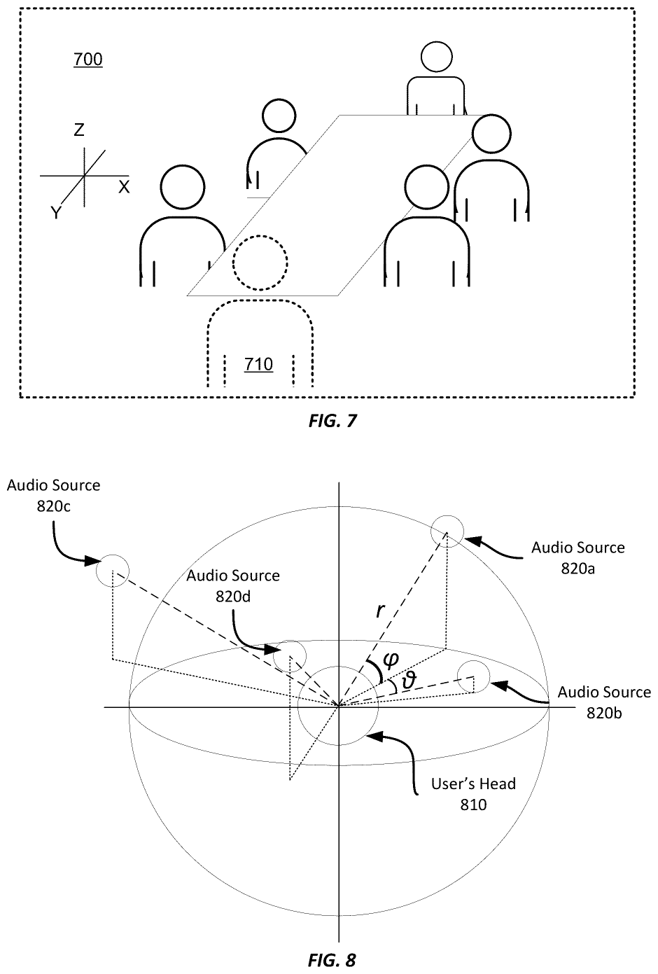

Referring now to FIG. 7, FIG. 7 shows a representation of a virtual conference room 700 to provide spatial audio in virtual conferences. The virtual conference room 700 corresponds to the virtual background 602 from FIG. 6, but the virtual conference room 700 is provided to illustrate how spatial audio may be employed using such a virtual background 602.

As discussed above, the virtual background 602 provides the look of a virtual conference room, over which video feeds from the various participants may be overlaid. Participant 710, which is shown in a dotted outline, corresponds to the user of the client device who is viewing the GUI 600 and illustrates their position within the virtual conference room 702.

To provide spatial audio, each participant displayed on the virtual background is assigned a location corresponding to their apparent position within the virtual conference room 702. In this example, each participant is assigned an (x,y,z) coordinate according to the coordinate axes shown in the Figure. The three-dimensional coordinates represent a location relative to the viewer of the virtual background, who may be positioned at an origin point, e.g., (0, 0, 0). Thus, each participant may be assigned their own coordinate, which may be used to determine a relative position of the respective participant, e.g., a distance, to the participant 710. After determining the relative positions for each participant in the virtual conference room 702, the software client can generate spatialized audio streams corresponding to each of the participants, which may vary based on relative distance from the user and based on whether the audio source is to the left or right of the user.

It should be appreciated that each software client may select positions for participants within the virtual background independently from other software clients. Thus, there may not be a common assignment of participants to the virtual conference room used by all software clients. However, in some examples one client device or the video conference provider may assign locations for each participant within the virtual conference room and provide the assigned locations to the other participants.

Further, it should be appreciated that while the virtual backgrounds 502, 602 discussed above may be represented by static images on which are overlaid the various participants' video feeds, in some examples, the virtual background may be a dynamic image or may be a three-dimensional environment rendered at the client device and within which the various video feeds may be positioned. Some such examples may provide a more immersive feel as it may allow participants to change their view into the virtual environment, which may not be permitted if a static images is used.

Referring now to FIG. 8, FIG. 8 shows an example representation of a user's head and multiple audio sources 820a-d within a virtual conference. Once the software client has established locations for each of the participants within the virtual background, it may then determine the relative locations of the different audio feeds to provide corresponding spatial audio. As is shown in FIG. 8, four audio sources 820a-d, corresponding to four participants in a conference, are positioned at different virtual locations within the background. The distances and angles of incidence and elevation for each audio source relative to the user's head 810 are determined. For example, the distance to audio source 820a is represented by r, while the angle of incidence to the X-axis is represented by and the angle of elevation about the X-Y plane is represented by ω. These values may be calculated trigonometrically based on the coordinate assigned to the user's head, e.g., (0,0,0), and the coordinate assigned to the audio source 820a. Once the distances and angles to each audio source 820a-d is determined, the software client may process incoming audio streams from each audio source based on the determined distances and angles to provide spatial audio cues to the user.

In some examples, to provide additional immersion within the virtual conference, the software client may also determine the orientation of the user's head 810 with respect to the virtual conference. If the orientation is not employed, the user's head may be assumed to be facing, for example, it may be assumed to be oriented and facing along the Y-axis into the virtual conference room 700. However, other examples, may determine an orientation for the user's head with respect to the virtual conference based on video captured by the camera on the user's client device. For example, the software client may use pose detection to analyze the captured video to determine an orientation of the user's head with respect to the screen on the user's client device and then project that orientation into the virtual conference. Thus user's orientation may thus affect the angles of incidence and elevation of the various audio sources 820 within the virtual conference.

Orientation may be projected by rotating a set of coordinate axes centered at the user's head according to the determined pose. Angles of incidence and elevation may then be determined based on the rotated set of coordinate axes. For example, if the user has tilted their face upward, it may reduce an angle of elevation for the audio sources 820a-d in FIG. 8. Further, if the user rotates their head to the right, it may similarly change the angles of incidence for each audio source 820a-d. The orientation may then be used by the software client to adjust the audio streams based not just on the relative position of the audio source to the user's head 810, but also based on the orientation of the user's head.

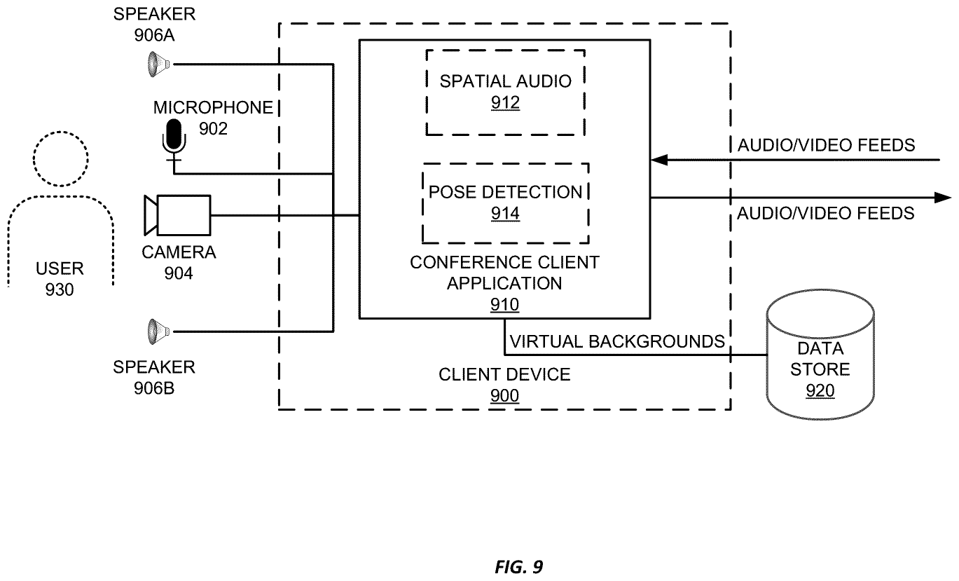

Referring now to FIG. 9, FIG. 9 shows an example client device 900 executing a conference client application 910, also referred to as software client 910, that includes spatial audio 912 and pose detection 914 functionality. The client device 900 is connected to a data store 920, which stores one or more virtual backgrounds usable during virtual conferences joined by the client device 900. The client device 900 is also connected to a microphone 902 and camera 904 to allow it to capture audio and video feeds to transmit during a virtual conference.

During a virtual conference, as discussed above with respect to FIGS. 1 and 2, the software client 910 exchanges audio and video feeds with a conference provider to enable the user 930 of the client device 900 to interact with other participants attending the virtual conference. When not employing spatial audio 912, the software client 910 receives audio feeds from the other participants in a virtual conference via the video conference provider and outputs them to the speakers 906a-b connected to the client device 900, e.g., desktop speakers or a headset worn by the user 930. Thus, the audio feed sounds however it was recorded at the corresponding participant's client device. However, the software client 910 may employ spatial audio 912 to process incoming audio streams to generate spatialized audio streams that may be output to the user 930 via the speakers 906a-b. Further, the software client 910 may employ pose detection 914 to determine the pose of the user's head based on images or video captured by the camera 904 and generate the spatialized audio streams based on the determined pose as well. Any suitable pose detection or estimation algorithm may be employed

During a virtual conference, the user 930 may select an option to use a virtual background, or the meeting's host may cause the participants in the conference to use a common background. The virtual background may then be obtained from the data store 920 or received from another participant's client device or the video conference provider. In this example, the virtual background includes information about pre-defined locations at which video feeds may be positioned within the virtual background, though the user may configure those parameters as well or instead.

Once the option to use the virtual background has been selected, a virtual background is selected or provided and the software client 910 crops and overlays the various participants' video feeds onto the virtual background as discussed above with respect to FIGS. 5 and 6. The user 930 may then select an option to employ spatialized audio, with or without pose detection. Depending on the user's selection, the software client 910 may employ one or both functionalities 912, 914.

If the user 930 elects to use spatial audio 912, incoming audio streams corresponding to the participants in the conference are each processed based on the relative position of the respective participant within the virtual background to generate two or more audio streams. One audio stream is generated for a left audio channel and a second audio stream is generated for a right audio channel. If more than two speakers are used, additional audio channels may be generated corresponding to the additional speakers and their respective positions relative to the user 930. For example, if the user is employing 5.1 audio, the spatial audio functionality 912 may generate audio streams for each of the right, left, and center channel from speakers, the left and right channel rear speakers, and the subwoofer. Further, if an incoming audio stream from a participant only has a single audio channel, the spatial audio functionality 912 may still generate two (or more) spatialized audio channels from of the single audio channel by using the single audio channel as the input audio channel for each output spatialized audio channel.

In this example the spatial audio functionality 912 employs a set of HRTFs to generate spatialized audio based on the location of a particular audio source and, in some examples, depending on the user's head pose. Each HRTF within the set of HRTFs defines a function based on spatial direction and distance to an audio source. Thus, depending on the location of the audio source relative to the user's head and, optionally, based on the user's head pose, a corresponding HRTF from the set of HRTFs is selected and used to generate spatialized audio streams. Moreover, in some examples different users may have different, customized sets of HRTFs based on their own head size and shape. Thus, a particular set of HRTFs may be selected based on the user.

In addition, it should be appreciated that at some times, multiple different people at different locations may speak at the same time. In such a case, the example system will generate a spatialized audio stream for each of these audio streams according to a corresponding HRTF based on the relative location of the sound source to the user's head. Each of the spatialized audio streams will then be combined into a single spatialized audio stream, which is then output to the user. Such an example may allow the user to more easily differentiate between the different speakers based on their respective locations with respect to the user.

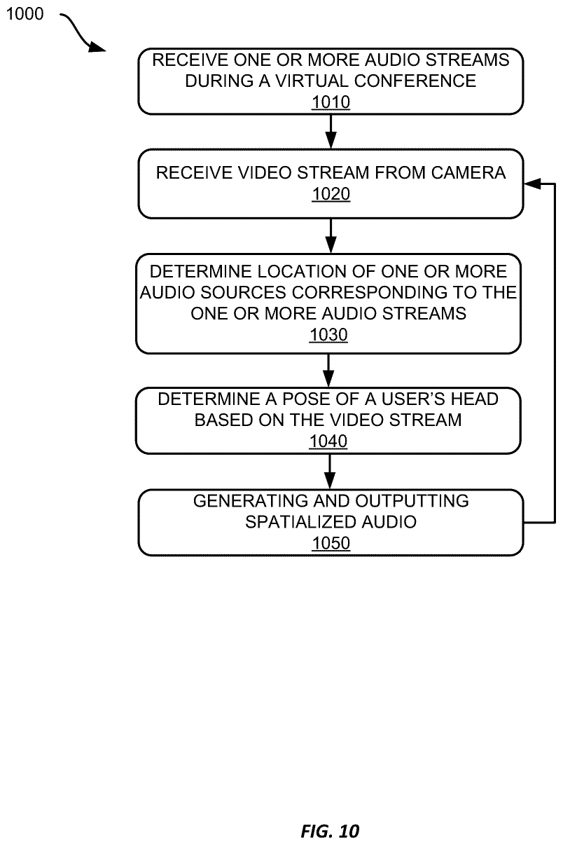

Referring now to FIG. 10, FIG. 10 shows an example method 1000 for providing spatial audio in virtual conferences. This example will be discussed with respect to the example GUI 600 shown in FIG. 6 and the example system 300 shown in FIG. 3 and the software client 910 shown in FIG. 9; however any suitable GUI or system according to this disclosure may be employed.

At block 1010, a user's client device 330 receives one or more audio streams from other client devices participating in a virtual conference hosted by a conference provider. As discussed above with respect to FIGS. 1 and 2, during a video conference, participants' client devices exchange audio and video streams through which the participants are able to interact with each other. In this example, while the various client devices may exchange both audio and video streams, providing spatialized audio may be accomplished even if one or more of the participants does not provide a corresponding video stream.

At block 1020, the user's client device 330 receives a video stream from the attached camera 904. The camera captures a video stream including the user and provides the video stream to the software client 910, which provides the video feed to the video conference provider.

At block 1030, the software client 910 determines the location of one or more audio sources corresponding to the one or more audio streams. As discussed above, a video conference may employ a virtual background over which participants' video streams may be cropped and overlaid. In some such examples, the virtual backgrounds may include location information corresponding to different positions within the virtual background. For example, the virtual background 502 in FIG. 5 includes four positions for participants within the two rows. Each of these positions may have an associated location, such as an (x, y) or (x, y, z) coordinate. Such location information may be included within the virtual background or may be provided separately. In some examples, the location information may be determined or generated locally at the user's client device 330. For example, the user may receive a virtual background from the video conference provider or another participant, or it may access one locally within its data store 920. The user may then assign locations to one or more positions established within the virtual background, or the user may establish both positions and corresponding locations within the virtual background.

To determine the location of one or more audio sources, the software client 910 may access the location information associated with the background and determine an audio stream associated with each position. For example, as participants join the conference, they may be assigned to different positions within the virtual background and associated with a corresponding location for the position. In some examples, the video conference provider or the software client 910 may assign participants to different positions within the background, each of which has an associated location.

As discussed above with respect to FIG. 7, in some examples, the virtual background may be a virtual three-dimensional space defined according to three coordinate axes. In such an example, participants may be able to position themselves within the virtual background, such as by using their mouse or arrow keys. Thus, the virtual three-dimensional space may enable more realistic interactions between participants within the space, since the participants may be able to dynamically move their own representations within the space. As the participants select an initial location or move within the three-dimensional space, the software client may determine the (x, y, z) locations of each of the participants, e.g., sources of audio streams, within the three-dimensional space.

At block 1040, the software client 910 determines a pose of the user's head based on the video stream received from the camera 904. As discussed above, the software client 910 may employ pose detection functionality 914 to analyze incoming video frames to determine the pose of the user's head. Any suitable pose detection technique may be employed to determine the pose of the user's head, such as any of the techniques disclosed or referenced in “Robust head pose estimation based on key frames for human-machine interaction,” by Madrigal et al, in the EURASIP Journal on Image and Video Processing (2020). It should be appreciated, however, the head pose detection is not required in all examples according to this disclosure. Instead, it is an optional feature that may provide a more immersive experience for the user, but may be omitted while still allowing the software client to provide spatial audio.

At block 1050, the software client 910 generates and outputs spatialized audio to the user, such as through one or more attached speakers 906a-b. To generate the spatialized audio, the software client 910 determines a distance to an audio source within the conference, such as a speaking participant, as well as an angle of incidence and an angle of elevation to the audio source from the user's head 810. In this example, the software client 910 then provides the distance and angle information to a HRTF selected from a set of HRTFs based on the direction and distance to the audio source as discussed above with respect to FIG. 9. If the software client 910 is not employing pose detection, an HRTF may also be provided with a default pose for the user's head, such as by assuming an orientation where the user is looking straight ahead at a display screen. However, if the software client 910 is employing pose detection 914, pose information generated by the pose detection functionality 914 may be provided to the selected HRTF as well. The software client 910 then also provides the corresponding audio stream to the selected HRTF.

After receiving the distance and angle information for the audio source and the user's head pose information, whether default pose information or pose information determined by pose detection functionality 914, the HRTF generates spatialized audio streams corresponding to the user's left and right ears, referred to as the left and right audio streams. The HRTF adjusts the volume and interaural time difference of audio signals at the user's ears to provide the illusion that the audio source is physically located at the apparent location within the virtual background. This may result in the left and right audio streams individually sounding different to the user, but collectively providing the auditory illusion discussed above. The left and right audio streams are then transmitted to the speakers or headphones corresponding to the user's left and right ears, respectively, where they are output to the user.

In cases where multiple different audio sources are active, e.g., multiple different participants are speaking at the same time, the software client generates spatialized audio streams for each audio source and combines them to provide a single set of left and right spatialized audio streams that are output to the user. As discussed above, this may enable the user to more easily differentiate between the different audio sources. It may also provide a more immersive experience as each audio source will sound to the user as though they are in physically different locations.

And while this example employs an HRTF, other examples may employ other techniques. For example, the system may determine a volume of the received audio stream for each of the user's ear based on the angle of incidence from the centerline of the user's apparent gaze direction. If pose detection is not employed, the user's gaze direction may be assumed to directly into the user's screen. However, if pose detection is employed a gaze direction may be determined based on the user's head's pose and the relative angle to the gaze direction may be used to adjust a relative volume of the left and right audio channels. For example, the farther the audio source is to the user's left, the lower the volume of the right audio channel may be adjusted. While such a technique is relatively simplistic as compared to a HRTF, it may provide some directionality to the audio streams to enable the user to determine whether the audio source is to the user's left or right, and by how much.

After block 1050, the method 1000 returns to block 1020 where the software client 910 continues to receive a video stream from the camera 904. In examples that employ pose detection, returning to block 1020 may allow continuous updates to the user's head pose during the conference, which may cause the software client to select a different HRTF to adjust the generated left and right audio streams due to changes in the user's head pose.

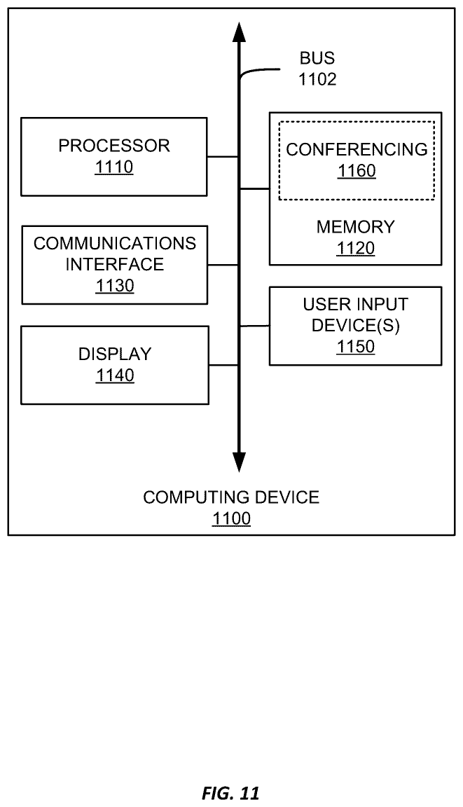

Referring now to FIG. 11, FIG. 11 shows an example computing device 1100 suitable for use in example systems or methods for providing spatial audio in virtual conferences according to this disclosure. The example computing device 1100 includes a processor 1110 which is in communication with the memory 1120 and other components of the computing device 1100 using one or more communications buses 1102. The processor 1110 is configured to execute processor-executable instructions stored in the memory 1120 to perform one or more methods for providing spatial audio in virtual conferences according to different examples, such as part or all of the example method 1000 described above with respect to FIG. 10. The computing device 1100, in this example, also includes one or more user input devices 1150, such as a keyboard, mouse, touchscreen, microphone, etc., to accept user input. The computing device 1100 also includes a display 1140 to provide visual output to a user.

In addition, the computing device 1100 includes a video conferencing application 1160 to enable a user to join and participate in one or more virtual spaces or in one or more conferences, such as a conventional conference or webinar, by receiving multimedia streams from a video conference provider, sending multimedia streams to the video conference provider, joining and leaving breakout rooms, creating video conference expos, etc., such as described throughout this disclosure, etc.

The computing device 1100 also includes a communications interface 1140. In some examples, the communications interface 1130 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving, at a client device from a conference provider, an audio stream associated with an audio source, the audio stream provided by a remote client device, the client device and the remote client device participating in a virtual conference hosted by the conference provider, the client device associated with a user;
determining a location of the audio source in the virtual conference with respect to the user's head;
generating a plurality of spatialized audio streams based on the locations of the audio source and the audio stream; and
outputting the spatialized audio streams.

2. The method of claim 1, further comprising:
receiving, at the client device from a camera connected to the client device, a user video stream;
determining a pose of a user's head in the user video stream; and
wherein generating the spatialized audio streams is further based on the pose of the user's head.

3. The method of claim 1, wherein the remote client device is a first remote client device of a plurality of remote client devices, each remote client device corresponding to one or more participants participating in the conference and each remote client device providing a respective audio stream associated with a respective audio source, and further comprising:
obtaining a virtual conference arrangement of the participants in the conference, wherein determining the locations of the audio sources is based on the virtual conference arrangement.

4. The method of claim 1, further comprising:
receiving a virtual conference arrangement from the conference provider, the virtual conference arrangement specifying locations of the user and other participants within a virtual conference room; and
wherein determining the location of the audio source comprises:
determining a location of a participant with respect to the user within the virtual conference room.

5. The method of claim 4, wherein the virtual conference room comprises a two-dimensional representation of a conference room.

6. The method of claim 4, wherein the virtual conference room comprises a three-dimensional representation of a conference room.

7. A system comprising:
a communications interface;
a non-transitory computer-readable medium; and
one or more processors communicatively coupled to the non-transitory computer-readable medium, the one or more processors configured to execute processor-executable instructions stored in the non-transitory computer-readable medium to:
receive, from a conference provider, an audio stream associated with an audio source, the audio stream provided by a remote client device, the system and the remote client device participating in a virtual conference hosted by the conference provider, the system associated with a user;
determine a location of the audio source in the virtual conference with respect to the user's head;
generate a plurality of spatialized audio streams based on the location of the audio source and the audio stream; and
output the spatialized audio streams.

8. The system of claim 7, further comprising a camera, and wherein the one or more processors are configured to execute further processor-executable instructions stored in the non-transitory computer-readable medium to:
receive, from the camera, a user video stream;
determine a pose of a user's head in the user video stream; and
generate the spatialized audio streams based on the pose of the user's head.

9. The system of claim 8, wherein the one or more processors are configured to execute further processor-executable instructions stored in the non-transitory computer-readable medium to:
determine a change in the pose of the user's head in the user video stream;
generate an updated spatialized audio stream based on the changed pose of the user's head, the location of the audio source, and the audio stream; and
output the plurality of updated spatialized audio streams.

10. The system of claim 7, wherein the remote client device is a first remote client device of a plurality of remote client devices, each remote client device corresponding to one or more participants participating in the conference and each remote client device providing a respective audio stream associated with a respective audio source, and wherein the one or more processors are configured to execute further processor-executable instructions stored in the non-transitory computer-readable medium to:
obtain a virtual conference arrangement of the participants in the conference, wherein determining the locations of the audio sources is based on the virtual conference arrangement.

11. The system of claim 7, wherein the one or more processors are configured to execute further processor-executable instructions stored in the non-transitory computer-readable medium to select a head-related transfer function (“HRTF”) from a set of HRTFs based on the location of the audio source and generate the plurality of spatialized audio streams based on the selected HRTF.

12. The system of claim 7, wherein the one or more processors are configured to execute further processor-executable instructions stored in the non-transitory computer-readable medium to:
determine a change in a location of an audio source;
generate a plurality of updated spatialized audio streams based on a pose of the user's head, the changed location of the audio source, and the audio stream; and
output the plurality of updated spatialized audio streams.

13. The system of claim 7, wherein the one or more processors are configured to execute further processor-executable instructions stored in the non-transitory computer-readable medium to:
receive a virtual conference arrangement from the conference provider, the virtual conference arrangement specifying locations of the user and other participants within a virtual conference room; and
determine a location of a participant with respect to the user within the virtual conference room.

14. A non-transitory computer-readable medium comprising processor-executable instructions configured to cause one or more processors to:
receive, at a client device from a conference provider, an audio stream associated with an audio source, the audio stream provided by a remote client device, the client device and the remote client device participating in a virtual conference hosted by the conference provider, the client device associated with a user;
determine a location of the audio source in the virtual conference with respect to the user's head;
generate a plurality of spatialized audio streams based on the locations of the audio source and the audio stream; and
output the spatialized audio streams.

15. The non-transitory computer-readable medium of claim 14, further comprising processor-executable instructions configured to cause the one or more processors to:
receive, from a camera, a user video stream;
determine a pose of a user's head in the user video stream; and
generate the plurality of spatialized audio streams based on the pose of the user's head.

16. The non-transitory computer-readable medium of claim 15, further comprising processor-executable instructions configured to cause the one or more processors to:
determine a change in a pose of the user's head in the user video stream;
generate an updated spatialized audio stream based on the changed pose of the user's head, the location of the audio source, and the audio stream; and
output the plurality of updated spatialized audio streams.

17. The non-transitory computer-readable medium of claim 15, further comprising processor-executable instructions configured to cause the one or more processors to:
determine a change in a location of an audio source in the video stream;
generate a plurality of updated spatialized audio streams based on the pose of the user's head, the changed location of the audio source, and the audio stream; and
output the plurality of updated spatialized audio streams.

18. The non-transitory computer-readable medium of claim 14, wherein the remote client device is a first remote client device of a plurality of remote client devices, each remote client device corresponding to one or more participants participating in the conference and each remote client device providing a respective audio stream associated with a respective audio source, and further comprising processor-executable instructions configured to cause the one or more processors to:
obtain a virtual conference arrangement of the participants in the conference, wherein determining the locations of the audio sources is based on the virtual conference arrangement.

19. The non-transitory computer-readable medium of claim 14, further comprising processor-executable instructions configured to cause the one or more processors to select a head-related transfer function (“HRTF”) from a set of HRTFs based on the location of the audio source and generate the plurality of spatialized audio streams based on the selected HRTF.

20. The non-transitory computer-readable medium of claim 14, further comprising processor-executable instructions configured to cause the one or more processors to:
receive a virtual conference arrangement from the conference provider, the virtual conference arrangement specifying locations of the user and other participants within a virtual conference room; and
determine a location of a participant with respect to the user within the virtual conference room.
